(19) United States
(12) Patent Application Publication
(10) Pub. No.: US 2025/0279659 A1
(43) Pub. Date: Sep. 4, 2025

(54) POWER SUPPLY DEVICE AND CONTROL METHOD FOR POWER SUPPLY DEVICE

(71) Applicant: HONDA MOTOR CO., LTD., Tokyo (JP)

(72) Inventor: Manabu Kurokawa, Tokyo (JP)

(21) Appl. No.: 19/052,325

(22) Filed: Feb. 13, 2025

(30) Foreign Application Priority Data
Mar. 1, 2024 (JP) 2024-031329

(51) Int. Cl. H02J 7/00; B60L 58/19

(52) U.S. Cl. CPC H02J 7/0024; B60L 58/19

(57) ABSTRACT

A power supply device includes: a switch circuit that includes a first power supply, a second power supply, and first to fifth switching elements; and a control device that switches between a parallel state in which the first power supply and the second power supply are connected in parallel to an inverter and the first power supply or the second power supply is connected to an auxiliary machine and a series state in which the first power supply and the second power supply are connected in series to the inverter and one of the first power supply and the second power supply is connected to the auxiliary machine by controlling the switch circuit.

### CROSS-REFERENCE TO RELATED APPLICATION

Priority is claimed on Japanese Patent Application No. 2024-031329, filed Mar. 1, 2024, the content of which is incorporated herein by reference.

### BACKGROUND OF THE INVENTION

### Field of the Invention

The present invention relates to a power supply device and a control method for a power supply device.

### Background Art

Recently, vehicles including a traveling motor instead of an engine as a power generation source or vehicles including a traveling motor along with an engine have increasingly spread toward a low-carbon society. Patent Document 1 discloses a power supply system for a vehicle including a main battery that supplies electric power to a traveling motor of the vehicle and a sub-battery that supplies electric power to an auxiliary machine.

[Patent Document] Japanese Patent No. 6888681

### SUMMARY OF THE INVENTION

In the power supply system for a vehicle disclosed in Patent Document 1, since two or more different batteries are mounted, different types of control are necessary for the batteries. Specifically, control of the traveling motor using electric power supplied from the main battery and control of a voltage applied to the auxiliary machine using electric power supplied from the sub battery are necessary. In this way, in the power supply system for a vehicle in which two different batteries are mounted, a controller for performing the control of a voltage applied to the auxiliary machine in addition to a controller for controlling the traveling motor is necessary, which causes an increase in cost and an increase in the number of installation places.

An aspect of the present invention was invented in consideration of the aforementioned circumstances, and an objective thereof is to provide a power supply device and a control method for a power supply device that can apply appropriate voltages to a traveling motor and an auxiliary machine without causing an increase in cost and an increase in the number of installation places.

In order to achieve the objective for solving the aforementioned problem, the present invention employs the following aspects.

(1) A power supply device according to an aspect of the present invention is a power supply device that includes a first power supply connected between a first node and a second node and a second power supply connected between a third node and a fourth node and that supplies electric power to a first electric load connected between the first node and the fourth node and a second electric load connected between a fifth node and a sixth node, the power supply device including: a switch circuit that includes a first switch connected between the first node and the fifth node, a second switch connected between the third node and the fifth node, a third switch connected between the second node and the third node, a fourth switch connected between the second node and the sixth node, and a fifth switch connected between the fourth node and the sixth node; and a control device that switches between a parallel state in which the first power supply and the second power supply are connected in parallel to the first electric load and the first power supply or the second power supply is connected to the second electric load by performing control such that the third switch of the switch circuit is open and the first switch, the second switch, the fourth switch, and the fifth switch are closed and a series state in which the first power supply and the second power supply are connected in series to the first electric load and one of the first power supply and the second power supply is connected to the second electric load by performing control such that the third switch is closed, the second switch and the fourth switch are open, one of the first switch and the fifth switch is closed, and the other thereof is open.

(2) In the aspect of (1), the first power supply may be connected to the second electric load when a voltage of the first power supply is larger than a voltage of the second power supply, and the second power supply may be connected to the second electric load when the voltage of the second power supply is larger than the voltage of the first power supply.

(3) In the aspect of (2), the control device may further include a voltage detecting unit that detects the voltages of the first power supply and the second power supply, and the control device may connect the first power supply to the second electric load by performing control such that the first switch is closed and the fifth switch is open when the voltage of the first power supply is larger than the voltage of the second power supply in the series state and connect the second power supply to the second electric load by performing control such that the first switch is open and the fifth switch is closed when the voltage of the second power supply is larger than the voltage of the first power supply.

(4) In the aspect of (3), the control device may first cause both the first switch and the fifth switch to be open and then cause the first switch to be closed when control is performed such that the first switch is closed and the fifth switch is open, and the control device may first cause both the first switch and the fifth switch to be open and then cause the fifth switch to be closed when control is performed such that the first switch is open and the fifth switch is closed.

(5) In any one of the aspects of (1) to (4), the control device may control the switch circuit such that a voltage applied to the first electric load changes slowly when switching between the parallel state and the series state is performed.

(6) In the aspect of (5), the control device may switch between the series state and the parallel state in a state in which the first power supply is connected to the second electric load by fixing the first switch of the switch circuit to a closed state and inversing and alternately switching a set of the third switch, the second switch, the fourth switch, and the fifth switch between an open state and a closed state.

(7) In the aspect of (5), the control device may switch between the series state and the parallel state in a state in which the second power supply is connected to the second electric load by fixing the fifth switch of the switch circuit to a closed state and inversing and alternately switching a set of the third switch, the first switch, the second switch, and the fourth switch between an open state and a closed state.

(8) In the aspect of (6) or (7), the control device may perform control such that a time in which the third switch is in the closed state increases slowly and a time in which the set of the plurality of switches is in the closed state decreases slowly when the parallel state is switched to the series state, and the control device may perform control such that a time in which the third switch is in the closed state decreases slowly and a time in which the set of the plurality of switches is in the closed state increases slowly when the series state is switched to the parallel state.

(9) In any one of the aspects of (1) to (8), the control device may further include: a first reactor disposed between the first power supply and the first node or the second node; and a second reactor disposed between the second power supply and the third node or the fourth node.

(10) A control method for a power supply device according to another aspect of the present invention is a control method for a power supply device that includes a first power supply connected between a first node and a second node and a second power supply connected between a third node and a fourth node and that supplies electric power to a first electric load connected between the first node and the fourth node and a second electric load connected between a fifth node and a sixth node, the power supply device including a switch circuit that includes a first switch connected between the first node and the fifth node, a second switch connected between the third node and the fifth node, a third switch connected between the second node and the third node, a fourth switch connected between the second node and the sixth node, and a fifth switch connected between the fourth node and the sixth node, and a control device that controls the switch circuit, the control method including: a step of causing the control device to switch to a parallel state in which the first power supply and the second power supply are connected in parallel to the first electric load and the first power supply or the second power supply is connected to the second electric load by performing control such that the third switch of the switch circuit is open and the first switch, the second switch, the fourth switch, and the fifth switch are closed; and a step of causing the control device to switch to a series state in which the first power supply and the second power supply are connected in series to the first electric load and one of the first power supply and the second power supply is connected to the second electric load by performing control such that the third switch is closed, the second switch and the fourth switch are open, one of the first switch and the fifth switch is closed, and the other thereof is open.

According to the aspects of (1) and (10), by switching a plurality of switches provided in the switch circuit between an open state and a closed state, the first power supply and the second power supply are connected in series or in parallel to the first electric load, and the first power supply or the second power supply is connected to the second electric load. Accordingly, it is possible to avoid a voltage in a state in which the first power supply and the second power supply are connected in series thereto being applied to the second electric load while applying the voltage in the state in which the first power supply and the second power supply are connected in series or applying a voltage in a state in which the first power supply and the second power supply are connected in parallel to the first electric load without causing an increase in cost and an increase in the number of installation places.

According to the aspects of (2) and (3), since one of the first power supply and the second power supply with a higher voltage is connected to the second electric load, it is possible to avoid the voltage of the first power supply and the voltage of the second power supply being unbalanced.

According to the aspect of (4), by avoiding the first switch and the fifth switch being simultaneously in the closed state, it is possible to avoid a voltage in a state in which the first power supply and the second power supply are connected in series being applied to the second electric load and to apply the appropriate voltage of only one of the first power supply and the second power supply to the second electric load to continuously operate.

According to the aspect of (5), since the voltage applied to the first electric load changes slowly when switching between the parallel state and the series state, it is possible to prevent deterioration of only one of the first power supply and the second power supply.

According to the aspects of (6) and (7), since the series state and the parallel state are switched between in a state in which the first power supply is connected to the second electric load or in a state in which the second power supply is connected to the second electric load, it is possible to switch between the series state and the parallel state while continuously supplying electric power to the second electric load.

According to the aspect of (8), since the parallel state and the series state are switched between by slowly changing a ratio of the length of time in which the third switch is in the closed state to the length of time in which the set of the second switch, the fourth switch, and the fifth switch or the set of the first switch, the second switch, and the fourth switch is in the closed state, it is possible to slowly change the voltage applied to the first electric load with simple control.

According to the aspect of (9), since the first reactor is provided between the first power supply and the first node or the second node and the second reactor is provided between the second power supply and the third node or the fourth node, it is possible to curb a sudden change in current when switching between the series state and the parallel state.

### BRIEF DESCRIPTION OF THE DRAWINGS

FIG. 1 is a circuit diagram illustrating a partial configuration of a power supply device according to an embodiment of the present invention.

FIG. 2 is a diagram illustrating an example of an operating state of the power supply device according to the embodiment of the present invention.

FIG. 3 is a diagram illustrating a current path when the power supply device according to the embodiment of the present invention is operating in a series mode.

FIG. 4 is a diagram illustrating an example of a change in voltage when the power supply device according to the embodiment of the present invention is operating in a series mode and switches between a first mode and a second mode.

FIG. 5 is a diagram illustrating a current path when the power supply device according to the embodiment of the present invention is operating in a parallel mode.

FIG. 6 is a diagram illustrating an example of a change in voltage when the power supply device according to the embodiment of the present invention is operating in a parallel mode.

FIG. 7 is a flowchart illustrating a control method for the power supply device according to the embodiment of the present invention.

### DETAILED DESCRIPTION OF THE INVENTION

Hereinafter, a power supply device and a control method for the power supply device according to an embodiment of the present invention will be described with reference to the accompanying drawings.

### Power Supply Device

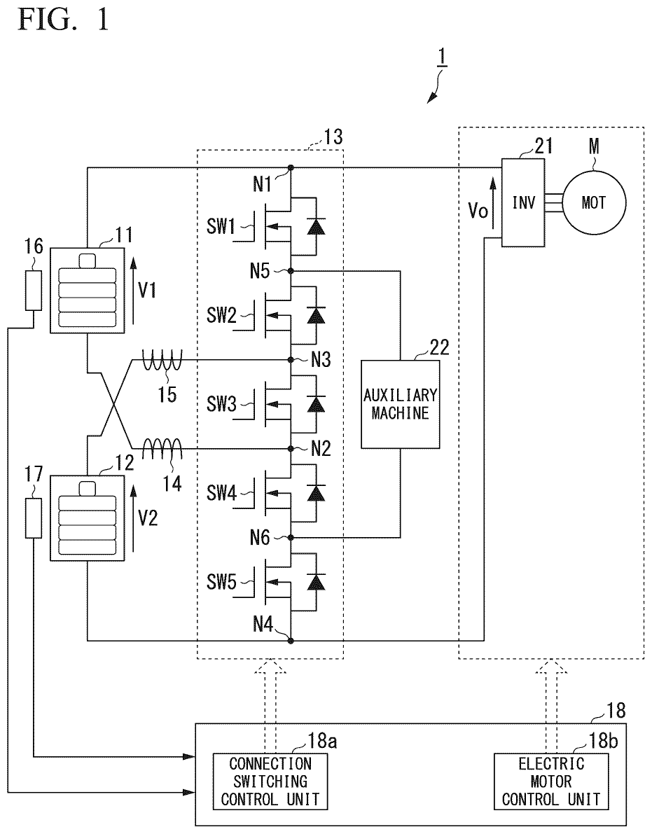

FIG. 1 is a circuit diagram illustrating a partial configuration of a power supply device according to an embodiment of the present invention. As illustrated in FIG. 1, a power supply device 1 according to the present embodiment includes a first power supply 11, a second power supply 12, a switch circuit 13, a first reactor 14, a second reactor 15, a voltage detecting unit 16, a voltage detecting unit 17, and a control device 18. The power supply device 1 supplies DC electric power to, for example, an inverter 21 (a first electric load) for controlling powering and regeneration of an electric motor M that generates a traveling drive force of a vehicle and an auxiliary machine 22 (a second electric load) that is installed in the vehicle. For example, a three-phase brushless DC motor can be used as the electric motor M.

The first power supply 11 is a chargeable/dischargeable secondary battery (for example, a battery). A positive electrode terminal of the first power supply 11 is connected to a first node N1, and a negative electrode terminal is connected to a second node N2. The second power supply 12 is a chargeable/dischargeable secondary battery (for example, a battery). A positive electrode terminal of the second power supply 12 is connected to a third node N3, and a negative electrode terminal is connected to a fourth node N4. The first power supply 11 and the second power supply 12 are the same power supply, and a voltage V1 of the first power supply 11 and a voltage V2 of the second power supply 12 are the same (or almost the same). The voltage V1 of the first power supply 11 and the voltage V2 of the second power supply 12 are a voltage (for example, 400 V) which is suitable for operating the auxiliary machine 22.

One end of the inverter 21 is connected to the first node N1, and the other end thereof is connected to a fourth node N4. One end of the auxiliary machine 22 is connected to a fifth node N5, and the other end thereof is connected to a sixth node N6.

The switch circuit 13 includes five switching elements (first to fifth switching elements SW1 to SW5 (first to fifth switches)) which are connected in series and switches connection states of the first power supply 11, the second power supply 12, the inverter 21, and the auxiliary machine 22 under the control of the control device 18. The first switching element SW1 is connected between the first node N1 and the fifth node N5, and the second switching element SW2 is connected between the third node N3 and the fifth node N5. The third switching element SW3 is connected between the second node N2 and the third node N3. The fourth switching element SW4 is connected between the second node N2 and the sixth node N6, and the fifth switching element SW5 is connected between the fourth node N4 and the sixth node N6.

Here, for example, metal-oxide-semiconductor field-effect transistors (MOSFETs) can be used as the first to fifth switching elements SW1 to SW5. Specific connection relations when MOSFETs are used as the first to fifth switching elements SW1 to SW5 are as follows. A drain of the first switching element SW1 is connected to the first node N1, and a source thereof is connected to the fifth node N5. A drain of the second switching element SW2 is connected to the fifth node N5, and a source thereof is connected to the third node N3. A drain of the third switching element SW3 is connected to the third node N3, and a source thereof is connected to the second node N2. A drain of the fourth switching element SW4 is connected to the second node N2, and a source thereof is connected to the sixth node N6. A drain of the fifth switching element SW5 is connected to the sixth node N6, and a source thereof is connected to the fourth node N4. A diode in which a forward direction is directed from the source to the drain is connected between the source and the drain of each of the first to fifth switching elements SW1 to SW5.

Switching of the switch circuit 13 is controlled, for example, according to a pulse width modulated signal (a PWM signal) which is output from the control device 18 and which is input to the gates of the first to fifth switching elements SW1 to SW5. A specific switching control method for the switch circuit 13 will be described later.

The first reactor 14 is provided between the first power supply 11 and the second node N2. More specifically, one end of the first reactor 14 is connected to a negative electrode terminal of the first power supply 11, and the other end is connected to a connection point between the source of the third switching element SW3 and the drain of the fourth switching element SW4. The second reactor 15 is provided between the second power supply 12 and the third node N3. More specifically, one end of the second reactor 15 is connected to a positive electrode terminal of the second power supply 12, and the other end is connected to a connection point between the source of the second switching element SW2 and the drain of the third switching element SW3.

The voltage detecting unit 16 detects the voltage V1 of the first power supply 11 and outputs a detection result thereof to the control device 18. The voltage detecting unit 17 detects the voltage V2 of the second power supply 12 and outputs a detection result to the control device 18.

The control device 18 includes, for example, a connection switching control unit 18a and an electric motor control unit 18b and performs switching control of the switch circuit 13 and drive control of the inverter 21. The connection switching control unit 18a switches connection states of the first power supply 11, the second power supply 12, the inverter 21, and the auxiliary machine 22 by performing the switching control of the switch circuit 13.

Here, the power supply device 1 according to the present embodiment includes a parallel mode and a series mode as operation modes. The parallel mode is a mode in which the power supply device 1 operates in a state (a parallel state) in which the first power supply 11 and the second power supply 12 are connected in parallel to the inverter 21 and the first power supply 11 or the second power supply 12 is connected to the auxiliary machine 22. The series mode is a mode in which the power supply device 1 operates in a state (a series state) in which the first power supply 11 and the second power supply 12 are connected in series to the inverter 21 and the first power supply 11 or the second power supply 12 is connected to the auxiliary machine 22. The connection switching control unit 18a controls the switch circuit 13 such that the parallel mode and the series mode are alternately switched between.

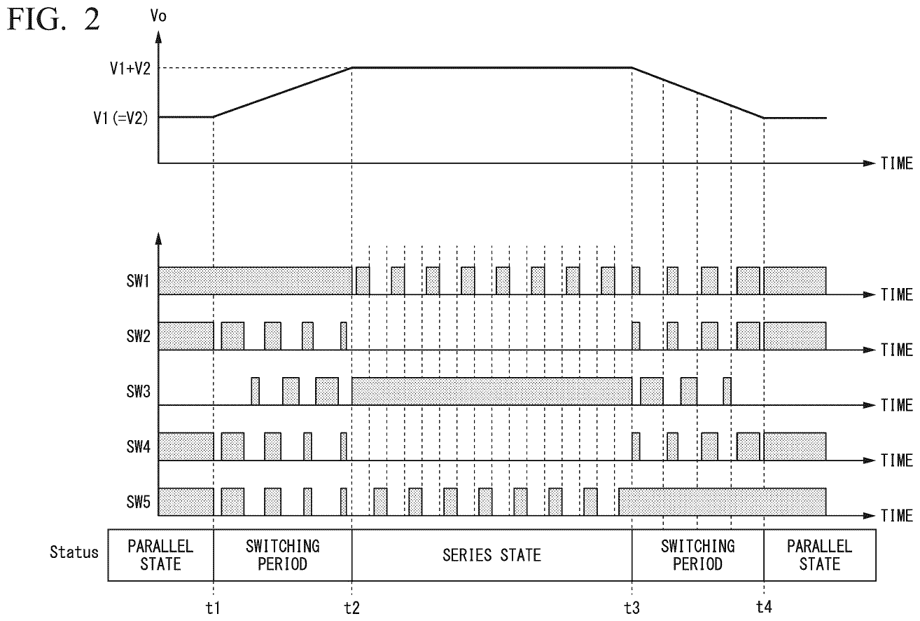

FIG. 2 is a diagram illustrating an example of an operating state of the power supply device according to the embodiment of the present invention. In the example illustrated in FIG. 2, the operating state (status) of the power supply device 1 is the parallel state before time t1 and after time t4 and is the series state between time t2 and time t3. A period between time t1 and time t2 is a switching period in which the parallel state is switched to the series state, and a period between time t3 and time t4 is a switching period in which the series state is switched to the parallel state.

When the operating state of the power supply device 1 is the parallel state, an output voltage Vo (a voltage applied to the inverter 21) of the power supply device 1 is the voltage V1 of the first power supply 11 (or the voltage V2 of the second power supply 12). On the other hand, when the operating state of the power supply device 1 is the series state, the output voltage Vo of the power supply device 1 is a sum voltage (V1+V2) of the voltage V1 of the first power supply 11 and the voltage V2 of the second power supply 12. In the switching period, the output voltage Vo of the power supply device 1 has a value between the voltage V1 of the first power supply 11 and the voltage V2 of the second power supply 12. Details of the operation modes and the operating states of the power supply device 1 will be described later.

For example, at the time of powered operation of the electric motor M, the electric motor control unit 18b converts DC electric power applied to a positive electrode terminal and a negative electrode terminal on the DC side of the inverter 21 to three-phase AC electric power and supplies phase currents of an AC current by sequentially commutating supply of a current to the phases of the electric motor M. On the other hand, for example, at the time of regenerative operation of the electric motor M, the electric motor control unit 18b converts AC generated electric power output from the electric motor M to DC electric power in synchronization with a rotation angle of the electric motor M.

### Series Mode

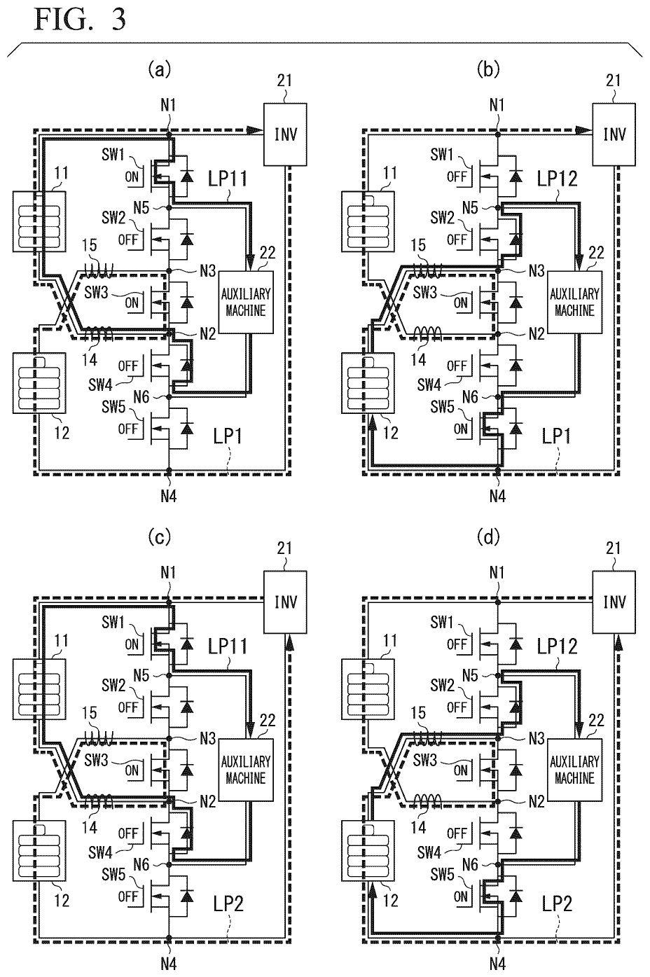

FIG. 3 are diagrams illustrating current paths when the power supply device according to the embodiment of the present invention operates in the series mode. In FIG. 3, the voltage detecting units 16 and 17, the control device 18, and the electric motor M are not illustrated. FIGS. 3(a) and 3(b) are diagrams illustrating current paths at the time of powered operation, and FIGS. 3(c) and 3(d) are diagrams illustrating current paths at the time of regenerative operation.

Here, at the time of any of powered operation and regenerative operation in the series mode, a mode (hereinafter referred to as a first mode) in which the first power supply 11 is connected to the auxiliary machine 22 and a mode (hereinafter referred to as a second mode) in which the second power supply 12 is connected to the auxiliary machine 22 are provided. FIG. 3(a) is a diagram illustrating a current path in the first mode at the time of powered operation, and FIG. 3(b) is a diagram illustrating a current path in the second mode at the time of powered operation. FIG. 3(c) is a diagram illustrating a current path in the first mode at the time of regenerative operation, and FIG. 3(d) is a diagram illustrating a current path in the second mode at the time of regenerative operation.

As illustrated in FIG. 3, at the time of any of powered operation and regenerative operation in the series mode, the connection switching control unit 18a of the control device 18 switches the third switching element SW3 to a closed state (ON) and switches the second switching element SW2 and the fourth switching element SW4 to an open state (OFF) (see FIG. 2).

Accordingly, as illustrated in FIGS. 3(a) and 3(b), a current loop LP1 passing sequentially through the second power supply 12, the second reactor 15, the third switching element SW3, the first reactor 14, the first power supply 11, and the inverter 21 is formed at the time of powered operation. On the other hand, as illustrated in FIGS. 3(c) and 3(d), a current loop LP2 passing sequentially through the inverter 21, the first power supply 11, the first reactor 14, the third switching element SW3, the second reactor 15, and the second power supply 12 is formed at the time of regenerative operation. A current flowing direction in the current loop LP2 is opposite to the current flowing direction in the current loop LP1 illustrated in FIGS. 3(a) and 3(b). In this way, at the time of any of powered operation and regenerative operation in the series mode, the first power supply 11 and the second power supply 12 are connected in series to the inverter 21.

As illustrated in FIGS. 3(a) and 3(c), at the time of any of powered operation and regenerative operation in the series mode, the connection switching control unit 18a of the control device 18 switches the first switching element SW1 to the closed state (ON) and switches the fifth switching element SW5 to the open state (OFF) in the first mode (see FIG. 2). Accordingly, a current loop LP11 passing sequentially through the first power supply 11, the first switching element SW1, the auxiliary machine 22, the fourth switching element SW4, and the first reactor 14 is formed. That is, the first power supply 11 is connected to the auxiliary machine 22.

As illustrated in FIGS. 3(b) and 3(d), at the time of any of powered operation and regenerative operation in the series mode, the connection switching control unit 18a of the control device 18 switches the first switching element SW1 to the open state (OFF) and switches the fifth switching element SW5 to the closed state (ON) in the second mode (see FIG. 2). Accordingly, a current loop LP12 passing sequentially through the second power supply 12, the second reactor 15, the second switching element SW2, the auxiliary machine 22, and the fifth switching element SW5 is formed. That is, the second power supply 12 is connected to the auxiliary machine 22.

The connection switching control unit 18a of the control device 18 switches between the first mode illustrated in FIGS. 3(a) and 3(c) and the second mode illustrated in FIGS. 3(b) and 3(d) on the basis of the detection results from the voltage detecting units 16 and 17. This switching is performed to make the voltage V1 of the first power supply 11 and the voltage V2 of the second power supply 12 the same (almost the same).

For example, at the time of any of powered operation and regenerative operation, the connection switching control unit 18a switches to the first mode when the voltage V1 of the first power supply 11 detected by the voltage detecting unit 16 is larger than the voltage V2 of the second power supply 12 detected by the voltage detecting unit 17. On the other hand, at the time of any of powered operation and regenerative operation, the connection switching control unit 18a switches to the second mode when the voltage V2 of the second power supply 12 detected by the voltage detecting unit 17 is larger than the voltage V1 of the first power supply 11 detected by the voltage detecting unit 16.

The connection switching control unit 18a may switch between the first mode and the second mode when a magnitude of a difference between the voltage V1 of the first power supply 11 detected by the voltage detecting unit 16 and the voltage V2 of the second power supply 12 detected by the voltage detecting unit 17 is greater than a predetermined threshold value. By performing switching on the basis of the magnitude of the difference, it is possible to avoid frequent occurrence of switching between the first mode and the second mode.

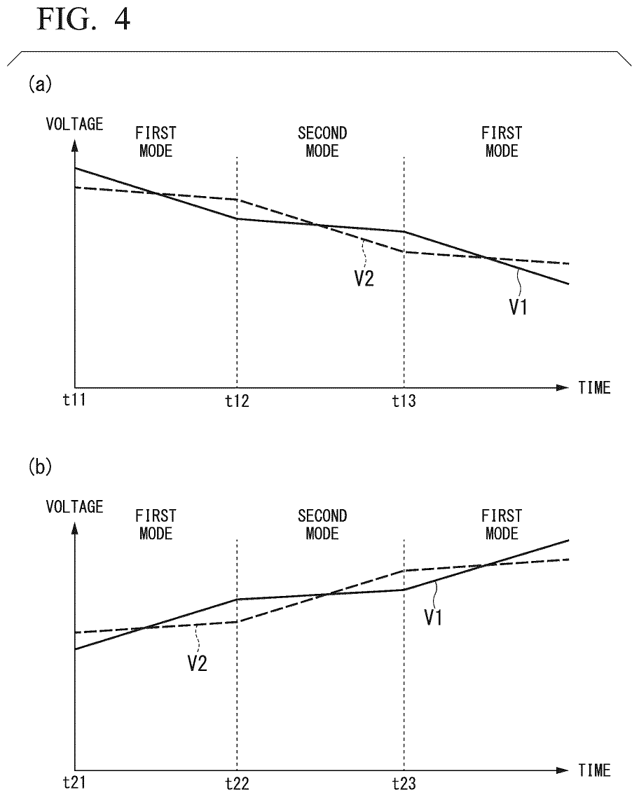

FIG. 4 are diagrams illustrating an example of a change in voltage at the time of switching between the first mode and the second mode when the power supply device according to the embodiment of the present invention is operating in the series mode. FIG. 4(a) is a diagram illustrating an example of a change in voltage at the time of powered operation, and FIG. 4(b) is a diagram illustrating an example of a change in voltage at the time of regenerative operation. In the examples illustrated in FIG. 4, when the magnitude of the difference between the voltage V1 of the first power supply 11 detected by the voltage detecting unit 16 and the voltage V2 of the second power supply 12 detected by the voltage detecting unit 17 is greater than the predetermined threshold value, switching between the first mode and the second mode is performed.

In the example illustrated in FIG. 4(a), at time t11, the magnitude of the difference between the voltage V1 of the first power supply 11 detected by the voltage detecting unit 16 and the voltage V2 of the second power supply 12 detected by the voltage detecting unit 17 is greater than the predetermined threshold value, and thus switching to the first mode is performed. When switching to the first mode is performed, electric power of the first power supply 11 is supplied to the auxiliary machine 22, and thus the voltage V1 of the first power supply 11 decreases slowly.

When the voltage V1 of the first power supply 11 decreases slowly and the magnitude of the difference between the voltage V1 of the first power supply 11 detected by the voltage detecting unit 16 and the voltage V2 of the second power supply 12 detected by the voltage detecting unit 17 becomes greater than the predetermined threshold value, switching to the second mode is performed (time t12). When switching to the second mode is performed, electric power of the second power supply 12 is supplied to the auxiliary machine 22, and thus the voltage V2 of the second power supply 12 decreases slowly.

When the voltage V2 of the second power supply 12 decreases slowly and the magnitude of the difference between the voltage V1 of the first power supply 11 detected by the voltage detecting unit 16 and the voltage V2 of the second power supply 12 detected by the voltage detecting unit 17 becomes greater than the predetermined threshold value, switching to the first mode is performed again (time t13). When switching to the first mode is performed, electric power of the first power supply 11 is supplied to the auxiliary machine 22, and thus the voltage V1 of the first power supply 11 decreases slowly. At the time of powered operation, by performing switching between the first mode and the second mode in this way, the voltage V1 of the first power supply 11 and the voltage V2 of the second power supply 12 decrease in almost the same way.

In the example illustrated in FIG. 4(b), at time t21, the magnitude of the difference between the voltage V1 of the first power supply 11 detected by the voltage detecting unit 16 and the voltage V2 of the second power supply 12 detected by the voltage detecting unit 17 is greater than the predetermined threshold value, and thus switching to the first mode is performed. When switching to the first mode is performed, electric power of the first power supply 11 is supplied to the auxiliary machine 22 but regenerated electric power is stored in the first power supply 11, and thus the voltage V1 of the first power supply 11 increases slowly.

When the voltage V1 of the first power supply 11 increases slowly and the magnitude of the difference between the voltage V1 of the first power supply 11 detected by the voltage detecting unit 16 and the voltage V2 of the second power supply 12 detected by the voltage detecting unit 17 becomes greater than the predetermined threshold value, switching to the second mode is performed (time t22). When switching to the second mode is performed, electric power of the second power supply 12 is supplied to the auxiliary machine 22 but regenerated electric power is stored in the second power supply 12, and thus the voltage V2 of the second power supply 12 increases slowly.

When the voltage V2 of the second power supply 12 increases slowly and the magnitude of the difference between the voltage V1 of the first power supply 11 detected by the voltage detecting unit 16 and the voltage V2 of the second power supply 12 detected by the voltage detecting unit 17 becomes greater than the predetermined threshold value, switching to the first mode is performed again (time t23). When switching to the first mode is performed, electric power of the first power supply 11 is supplied to the auxiliary machine 22 but regenerated electric power is stored in the first power supply 11, and thus the voltage V1 of the first power supply 11 increases slowly. At the time of regenerative operation, by performing switching between the first mode and the second mode in this way, the voltage V1 of the first power supply 11 and the voltage V2 of the second power supply 12 increase in almost the same way.

Here, when switching from the second mode to the first mode is performed, the connection switching control unit 18a first switches the first switching element SW1 and the fifth switching element SW5 to the open state and then switches the first switching element SW1 to the closed state (see FIG. 2). When switching from the first mode and the second mode is performed, the connection switching control unit 18a first switches the first switching element SW1 and the fifth switching element SW5 to the open state and then switches the fifth switching element SW5 to the closed state (see FIG. 2). Accordingly, it is possible to avoid application of a voltage in the state in which the first power supply 11 and the second power supply 12 are connected in series to the auxiliary machine 22.

### Parallel Mode

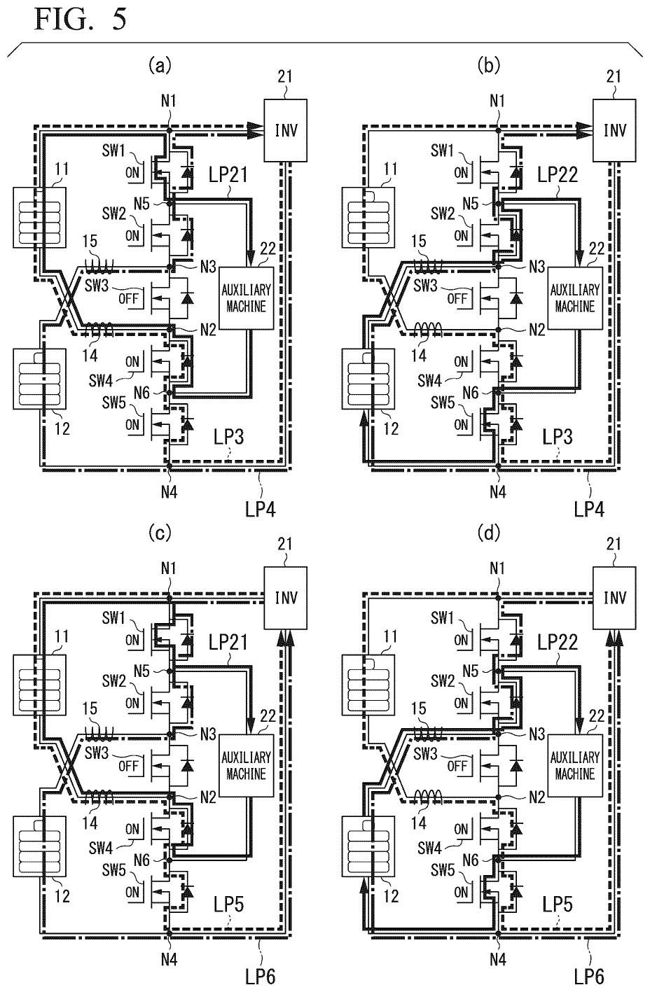

FIG. 5 are diagrams illustrating current paths when the power supply device according to the embodiment of the present invention operates in the parallel mode. In FIG. 5, similarly to FIG. 3, the voltage detecting units 16 and 17, the control device 18, and the electric motor M are not illustrated. FIGS. 5(a) and 5(b) are diagrams illustrating current paths at the time of powered operation, and FIGS. 5(c) and 5(d) are diagrams illustrating current paths at the time of regenerative operation.

Here, at the time of any of powered operation and regenerative operation in the parallel mode, similarly to the series mode, a first mode in which the first power supply 11 is connected to the auxiliary machine 22 and a second mode in which the second power supply 12 is connected to the auxiliary machine 22 are provided. FIG. 5(a) is a diagram illustrating a current path in the first mode at the time of powered operation, and FIG. 5(b) is a diagram illustrating a current path in the second mode at the time of powered operation. FIG. 5(c) is a diagram illustrating a current path in the first mode at the time of regenerative operation, and FIG. 5(d) is a diagram illustrating a current path in the second mode at the time of regenerative operation.

As illustrated in FIG. 5, at the time of any of powered operation and regenerative operation in the parallel mode, the connection switching control unit 18a of the control device 18 switches the third switching element SW3 to the open state (OFF) and switches the first switching element SW1, the second switching element SW2, the fourth switching element SW4, and the fifth switching element SW5 to the closed state (ON) (see FIG. 2).

Accordingly, as illustrated in FIGS. 5(a) and 5(b), a current loop LP3 passing sequentially through the first power supply 11, the inverter 21, the fifth switching element SW5, the fourth switching element SW4, and the first reactor 14 and a current loop LP4 passing sequentially through the second power supply 12, the second reactor 15, the second switching element SW2, the first switching element SW1, and the inverter 21 are formed at the time of powered operation.

On the other hand, as illustrated in FIGS. 5(c) and 5(d), a current loop LP5 passing sequentially through the inverter 21, the first power supply 11, the first reactor 14, the fourth switching element SW4, and the fifth switching element SW5 and a current loop LP6 passing sequentially through the inverter 21, the first switching element SW1, the second switching element SW2, the second reactor 15, and the second power supply 12 are formed at the time of regenerative operation. A current flowing direction in the current loops LP5 and 6 are opposite to the current flowing direction in the current loops LP3 and L4 illustrated in FIGS. 5(a) and 5(b). In this way, at the time of any of powered operation and regenerative operation in the parallel mode, the first power supply 11 and the second power supply 12 are connected in parallel to the inverter 21.

As illustrated in FIGS. 5(a) and 5(c), at the time of any of powered operation and regenerative operation, a current loop LP21 passing sequentially through the first power supply 11, the first switching element SW1, the auxiliary machine 22, the fourth switching element SW4, and the first reactor 14 is formed in the first mode. That is, the first power supply 11 is connected to the auxiliary machine 22. The current loop LP21 is the same as the current loop LP11 illustrated in FIGS. 3(a) and 3(c).

As illustrated in FIGS. 5(b) and 5(d), at the time of any of powered operation and regenerative operation, a current loop LP22 passing sequentially through the second power supply 12, the second reactor 15, the second switching element SW2, the auxiliary machine 22, and the fifth switching element SW5 is formed in the second mode. That is, the second power supply 12 is connected to the auxiliary machine 22. The current loop LP22 is the same as the current loop LP12 illustrated in FIGS. 3(b) and 3(d).

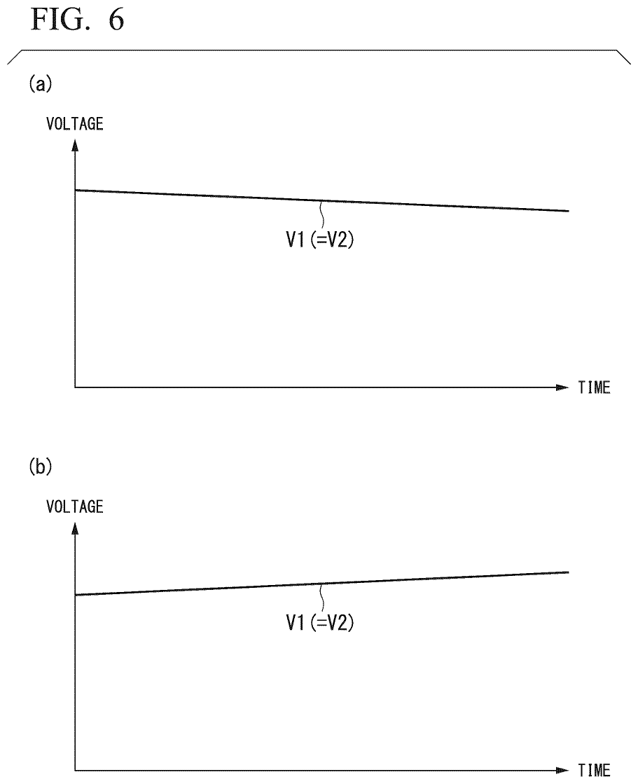

FIG. 6 are diagrams illustrating an example of a change in voltage when the power supply device according to the embodiment of the present invention is operating in the parallel mode. FIG. 6(a) is a diagram illustrating an example of a change in voltage at the time of powered operation, and FIG. 6(d) is a diagram illustrating an example of a change in voltage at the time of regenerative operation.

Here, in the series mode, the connection switching control unit 18a of the control device 18 controls the first switching element SW1 and the fifth switching element SW5 such that switching between the first mode and the second mode is performed. On the other hand, in the parallel mode, the connection switching control unit 18a of the control device 18 switches the third switching element SW3 to the open state (OFF) and switches the first switching element SW1, the second switching element SW2, the fourth switching element SW4, and the fifth switching element SW5 to the closed state (ON). In the parallel mode, switching between the first mode and the second mode is automatically performed by a natural current on the basis of the magnitude relationship between the voltage V1 of the first power supply 11 and the voltage V2 of the second power supply 12.

At the time of powered operation, switching between the first mode and the second mode is automatically performed on the basis of the magnitude relationship between the voltage V1 of the first power supply 11 and the voltage V2 of the second power supply 12, and supply of electric power from the first power supply 11 to the auxiliary machine 22 and supply of electric power from the second power supply 12 to the auxiliary machine 22 are alternately performed. Accordingly, as illustrated in FIG. 6(a), the voltage V1 of the first power supply 11 and the voltage V2 of the second power supply 12 decrease slowly, and the voltage V1 of the first power supply 11 and the voltage V2 of the second power supply 12 become almost the same.

At the time of regenerative operation, switching between the first mode and the second mode is automatically performed on the basis of the magnitude relationship between the voltage V1 of the first power supply 11 and the voltage V2 of the second power supply 12, and supply of electric power from the first power supply 11 to the auxiliary machine 22 and supply of electric power from the second power supply 12 to the auxiliary machine 22 are alternately performed. Here, at the time of regenerative operation, since regenerated electric power is alternately stored in the first power supply 11 and the second power supply 12, the voltage V1 of the first power supply 11 and the voltage V2 of the second power supply 12 increase slowly, and the voltage V1 of the first power supply 11 and the voltage V2 of the second power supply 12 become almost the same as illustrated in FIG. 6(d).

### Switching Between Parallel Mode and Series Mode

The connection switching control unit 18a of the control device 18 controls the switch circuit 13 such that switching between the parallel mode and the series mode is performed. When switching between the parallel mode and the series mode is performed, the connection switching control unit 18a controls the switch circuit 13 such that the output voltage Vo of the power supply device 1 changes slowly as illustrated in FIG. 2. Here, a switching method in a state in which the first power supply 11 is connected to the auxiliary machine 22 (hereinafter referred to as a first switching mode) and a switching method in a state in which the second power supply 12 is connected to the auxiliary machine 22 (hereinafter referred to as a second switching mode) are used as a method of switching between the parallel mode and the series mode.

The first switching mode is used when the voltage V1 of the first power supply 11 is larger than the voltage V2 of the second power supply 12. The second switching mode is used when the voltage V2 of the second power supply 12 is larger than the voltage V1 of the first power supply 11.

In the first switching mode, the connection switching control unit 18a fixes the first switching element SW1 of the switch circuit 13 to the closed state. Then, the connection switching control unit 18a inverts and alternately switches a set of the third switching element SW3, the second switching element SW2, the fourth switching element SW4, and the fifth switching element SW5 between the open state and the closed state (see the switching period between time t1 and time t2 in FIG. 2). That is, the connection switching control unit 18a alternately switches between the state illustrated in FIG. 3(a) or 3(c) and the state illustrated in FIG. 5(a) or 5(c).

In the second switching mode, the connection switching control unit 18a fixes the fifth switching element SW5 of the switch circuit 13 to the closed state. Then, the connection switching control unit 18a inverts and alternately switches a set of the third switching element SW3, the first switching element SW1, the second switching element SW2, and the fourth switching element SW4 between the open state and the closed state (see the switching period between time t3 and time t4 in FIG. 2). That is, the connection switching control unit 18a alternately switches between the state illustrated in FIG. 3(b) or 3(d) and the state illustrated in FIG. 5(b) or 5(d).

When switching from the parallel state to the series state is performed and when switching from the series state to the parallel state is performed, the first switching mode and the second switching mode can be used. Specifically, when switching from the parallel state to the series state is performed, the first switching mode can be used when the voltage V1 of the first power supply 11 is larger than the voltage V2 of the second power supply 12, and the second switching mode can be used when the voltage V2 of the second power supply 12 is larger than the voltage V1 of the first power supply 11. Even when switching from the series state to the parallel state is performed, the first switching mode can be used when the voltage V1 of the first power supply 11 is larger than the voltage V2 of the second power supply 12, and the second switching mode can be used when the voltage V2 of the second power supply 12 is larger than the voltage V1 of the first power supply 11.

When switching from the parallel state to the series state is performed using the first switching mode, the connection switching control unit 18a performs control such that a time in which the third switching element SW3 is in the closed state increases slowly and a time in which a set of the second switching element SW2, the fourth switching element SW4, and the fifth switching element SW5 is in the closed state decreases slowly (see the switching period between time t1 and time t2 in FIG. 2). Specifically, the connection switching control unit 18a controls a set of the third switching element SW3, the second switching element SW2, the fourth switching element SW4, and the fifth switching element SW5 such that a duty (period of series state/(period of parallel state+period of series state) changes from 0% to 100%. A control frequency ranges, for example, from 10 kHz to 300 kHz.

When switching from the parallel state to the series state is performed using the second switching mode, the connection switching control unit 18a performs control such that the time in which the third switching element SW3 is in the closed state increases slowly and the time in which the set of the first switching element SW1, the second switching element SW2, and the fourth switching element SW4 is in the closed state decreases slowly (see the switching period between time t3 and time t4 in FIG. 2). Specifically, the connection switching control unit 18a controls a set of the third switching element SW3, the first switching element SW1, the second switching element SW2, and the fourth switching element SW4 such that the duty changes from 0% to 100%.

When switching from the series state to the parallel state is performed using the second switching mode, the connection switching control unit 18a performs control such that the time in which the third switching element SW3 is in the closed state decreases slowly and the time in which the set of the first switching element SW1, the second switching element SW2, and the fourth switching element SW4 is in the closed state increases slowly (refer to switching period between time t3 and time t4 of FIG. 2). Specifically, the connection switching control unit 18a controls a set of the third switching element SW3, the first switching element SW1, the second switching element SW2, and the fourth switching element SW4 such that the duty changes from 100% to 0%.

When switching from the series state to the parallel state is performed using the first switching mode, the connection switching control unit 18a performs control such that the time in which the third switching element SW3 is in the closed state decreases slowly and the time in which the set of the second switching element SW2, the fourth switching element SW4, and the fifth switching element SW5 is in the closed state increases slowly. Specifically, the connection switching control unit 18a controls a set of the third switching element SW3, the second switching element SW2, the fourth switching element SW4, and the fifth switching element SW5 such that the duty changes from 100% to 0%.

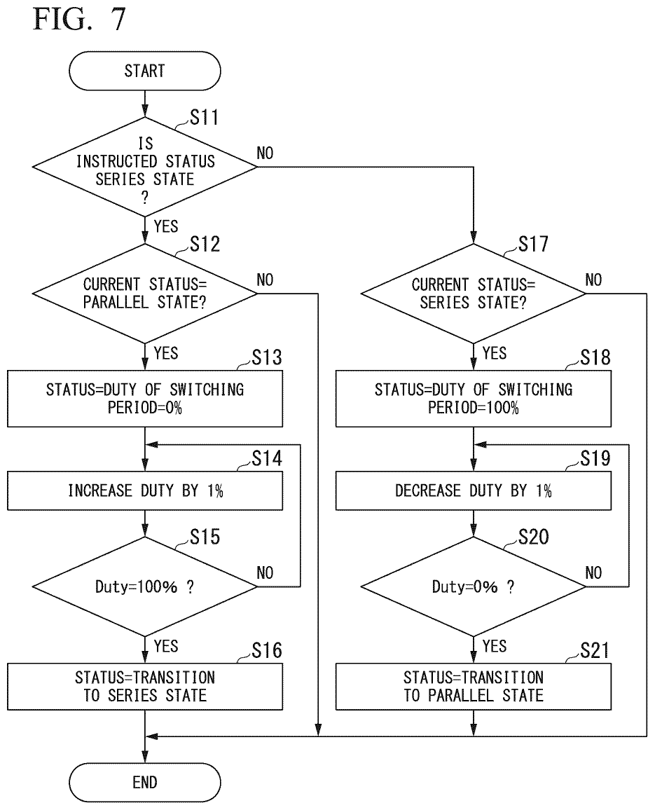

FIG. 7 is a flowchart illustrating a control method for the power supply device according to the embodiment of the present invention. The flowchart illustrated in FIG. 7 represents a process flow that is performed when switching between the parallel state and the series state is performed. The flowchart illustrated in FIG. 7 starts, for example, when a host device (not illustrated) instructs a status to the control device 18 of the power supply device 1.

When the process flow starts, the connection switching control unit 18a of the control device 18 determines whether the status instructed by the host device is the series state (Step S11). When it is determined that the status instructed by the host device is the series state, the connection switching control unit 18a determines whether a current status of the power supply device 1 is the parallel state (Step S12). When it is determined that the current status of the power supply device 1 is not the parallel state, the connection switching control unit 18a ends the process flow illustrated in FIG. 7.

On the other hand, when it is determined that the current status of the power supply device 1 is the parallel state, the connection switching control unit 18a set a period in which the status of the power supply device 1 is switched and sets the duty to 0% (Step S13). Then, the connection switching control unit 18a increases the duty by 1% (Step S14). Subsequently, the connection switching control unit 18a determines whether the duty is 100% (Step S15).

When it is determined that the duty is not 100%, the process flow returns to Step S14, and the connection switching control unit 18a increases the duty by 1%. Then, the connection switching control unit 18a determines whether the duty is 100% again (Step S15). That is, until it is determined in Step S15 that the duty is 100%, the process of Step S14 is performed, and the duty is increased by 1%.

By performing this process, for example, control illustrated in the switching period between time t1 and time t2 in FIG. 2 is performed. That is, control is performed such that the time in which the third switching element SW3 is in the closed increases slowly and the time in which the set of the second switching element SW2, the fourth switching element SW4, and the fifth switching element SW5 is in the closed state decreases slowly. When it is determined that the duty is 100%, the connection switching control unit 18a causes the status of the power supply device 1 to transition to the series state (Step S16). When this process ends, the connection switching control unit 18a ends the process flow illustrated in FIG. 7.

On the other hand, when it is determined that the status instructed by the host device is not the series state, the connection switching control unit 18a determines whether the current status of the power supply device 1 is the series state (Step S17). When it is determined that the current status of the power supply device 1 is not the series state, the connection switching control unit 18a ends the process flow illustrated in FIG. 7.

On the other hand, when it is determined that the current status of the power supply device 1 is the series state, the connection switching control unit 18a set a period in which the status of the power supply device 1 is switched and sets the duty to 100% (Step S18). Then, the connection switching control unit 18a decreases the duty by 1% (Step S19). Subsequently, the connection switching control unit 18a determines whether the duty is 0% (Step S20).

When it is determined that the duty is not 0%, the process flow returns to Step S19, and the connection switching control unit 18a decreases the duty by 1%. Then, the connection switching control unit 18a determines whether the duty is 0% again (Step S20). That is, until it is determined in Step S20 that the duty is 0%, the process of Step S19 is performed, and the duty is decreased by 1%.

By performing this process, for example, control illustrated in the switching period between time t3 and time t4 in FIG. 2 is performed. That is, control is performed such that the time in which the third switching element SW3 is in the closed state decreases slowly and the time in which the set of the first switching element SW1, the second switching element SW2, and the fourth switching element SW4 is in the closed state increases slowly. When it is determined that the duty is 0%, the connection switching control unit 18a causes the status of the power supply device 1 to transition to the parallel state (Step S21). When this process ends, the connection switching control unit 18a ends the process flow illustrated in FIG. 7.

As described above, the power supply device 1 according to the present embodiment includes the first power supply 11 that is connected between the first node N1 and the second node N2 and the second power supply 12 that is connected between the third node N3 and the fourth node N4. The power supply device 1 supplies electric power to the inverter 21 connected between the first node N1 and the fourth node N4 and the auxiliary machine 22 connected between the fifth node N5 and the sixth node N6.

The power supply device 1 includes the switch circuit 13 and the control device 18. The switch circuit 13 includes the first switching element SW1 connected between the first node N1 and the fifth node N5, the second switching element SW2 connected between the third node N3 and the fifth node N5, the third switching element SW3 connected between the second node N2 and the third node N3, the fourth switching element SW4 connected between the second node N2 and the sixth node N6, and the fifth switching element SW5 connected between the fourth node N4 and the sixth node N6.

The control device 18 switches between the parallel state and the series state. The parallel state is a state in which the first power supply 11 and the second power supply 12 are connected in parallel to the inverter 21 and the first power supply 11 or the second power supply 12 is connected to the auxiliary machine 22. The series state is a state in which the first power supply 11 and the second power supply 12 are connected in series to the inverter 21 and the one of the first power supply 11 and the second power supply 12 is connected to the auxiliary machine 22.

When switching to the parallel state is performed, the control device 18 performs control such that the third switching element SW3 of the switch circuit is in the open state and the first switching element SW1, the second switching element SW2, the fourth switching element SW4, and the fifth switching element SW5 are in the closed state. When switching to the series state is performed, the control device 18 performs control such that the third switching element SW3 is in the closed state, the second switching element SW2 and the fourth switching element SW4 are in the open state, and one of the first switching element SW1 and the fifth switching element SW5 is in the closed state.

Accordingly, by only switching a plurality of switching elements provided in the switch circuit 13 between the open state and the closed state, the first power supply 11 and the second power supply 12 are connected in series or in parallel to the inverter 21, and the first power supply 11 or the second power supply 12 is connected to the auxiliary machine 22. Accordingly, it is possible to supply appropriate electric power to the inverter 21 and the auxiliary machine 22 without causing an increase in cost and an increase in the number of installation places.

While a mode for carrying out the present invention has been described above in conjunction with an embodiment, the present invention is not limited to the embodiment and can be subjected to various modifications and substitutions without departing from the gist of the present invention. For example, in the aforementioned embodiment, an example in which the first reactor 14 is provided between the first power supply 11 and the second node N2 and the second reactor 15 is provided between the second power supply 12 and the third node N3 has been described above. However, the first reactor 14 may be provided between the first power supply 11 and the first node N1. Similarly, the second reactor 15 may be provided between the second power supply 12 and the fourth node N4.

The control device 18 can be realized by a computer such as a built-in computer. When the control device 18 is realized by a computer, functions of the constituent units in the control device 18 are realized by causing a central processing unit (CPU) installed in the computer to execute a program for realizing the functions. That is, the functions of the constituent units in the control device 18 are cooperatively realized by software and hardware resources. The control device 18 may be realized by hardware such as a field-programmable gate array (FPGA), a large scale integration (LSI) circuit, or an application-specific integrated circuit (ASIC).

What is claimed is:

1. A power supply device that includes a first power supply connected between a first node and a second node and a second power supply connected between a third node and a fourth node and that supplies electric power to a first electric load connected between the first node and the fourth node and a second electric load connected between a fifth node and a sixth node, the power supply device comprising:
a switch circuit that includes a first switch connected between the first node and the fifth node, a second switch connected between the third node and the fifth node, a third switch connected between the second node and the third node, a fourth switch connected between the second node and the sixth node, and a fifth switch connected between the fourth node and the sixth node; and
a control device that switches between a parallel state in which the first power supply and the second power supply are connected in parallel to the first electric load and the first power supply or the second power supply is connected to the second electric load by performing control such that the third switch of the switch circuit is open and the first switch, the second switch, the fourth switch, and the fifth switch are closed and a series state in which the first power supply and the second power supply are connected in series to the first electric load and one of the first power supply and the second power supply is connected to the second electric load by performing control such that the third switch is closed, the second switch and the fourth switch are open, one of the first switch and the fifth switch is closed, and the other thereof is open.

2. The control device according to claim 1, wherein the first power supply is connected to the second electric load when a voltage of the first power supply is larger than a voltage of the second power supply, and
wherein the second power supply is connected to the second electric load when the voltage of the second power supply is larger than the voltage of the first power supply.

3. The control device according to claim 2, further comprising a voltage detecting unit that detects the voltages of the first power supply and the second power supply,
wherein the control device connects the first power supply to the second electric load by performing control such that the first switch is closed and the fifth switch is open when the voltage of the first power supply is larger than the voltage of the second power supply in the series state and connects the second power supply to the second electric load by performing control such that the first switch is open and the fifth switch is closed when the voltage of the second power supply is larger than the voltage of the first power supply.

4. The power supply device according to claim 3, wherein the control device first causes both the first switch and the fifth switch to be open and then causes the first switch to be closed when control is performed such that the first switch is closed and the fifth switch is open, and
wherein the control device first causes both the first switch and the fifth switch to be open and then causes the fifth switch to be closed when control is performed such that the first switch is open and the fifth switch is closed.

5. The control device according to claim 1, wherein the control device controls the switch circuit such that a voltage applied to the first electric load changes slowly when switching between the parallel state and the series state is performed.

6. The control device according to claim 5, wherein the control device switches between the series state and the parallel state in a state in which the first power supply is connected to the second electric load by fixing the first switch of the switch circuit to a closed state and inversing and alternately switching a set of the third switch, the second switch, the fourth switch, and the fifth switch between an open state and a closed state.

7. The control device according to claim 5, wherein the control device switches between the series state and the parallel state in a state in which the second power supply is connected to the second electric load by fixing the fifth switch of the switch circuit to a closed state and inversing and alternately switching a set of the third switch, the first switch, the second switch, and the fourth switch between an open state and a closed state.

8. The control device according to claim 6, wherein the control device performs control such that a time in which the third switch is in the closed state increases slowly and a time in which the set of the plurality of switches is in the closed state decreases slowly when the parallel state is switched to the series state, and
wherein the control device performs control such that a time in which the third switch is in the closed state decreases slowly and a time in which the set of the plurality of switches is in the closed state increases slowly when the series state is switched to the parallel state.

9. The control device according to claim 1, further comprising:
a first reactor disposed between the first power supply and the first node or the second node; and
a second reactor disposed between the second power supply and the third node or the fourth node.

10. A control method for a power supply device that includes a first power supply connected between a first node and a second node and a second power supply connected between a third node and a fourth node and that supplies electric power to a first electric load connected between the first node and the fourth node and a second electric load connected between a fifth node and a sixth node, the power supply device including a switch circuit that includes a first switch connected between the first node and the fifth node, a second switch connected between the third node and the fifth node, a third switch connected between the second node and the third node, a fourth switch connected between the second node and the sixth node, and a fifth switch connected between the fourth node and the sixth node, and a control device that controls the switch circuit, the control method comprising:
a step of causing the control device to switch to a parallel state in which the first power supply and the second power supply are connected in parallel to the first electric load and the first power supply or the second power supply is connected to the second electric load by performing control such that the third switch of the switch circuit is open and the first switch, the second switch, the fourth switch, and the fifth switch are closed; and
a step of causing the control device to switch to a series state in which the first power supply and the second power supply are connected in series to the first electric load and one of the first power supply and the second power supply is connected to the second electric load by performing control such that the third switch is closed, the second switch and the fourth switch are open, one of the first switch and the fifth switch is closed, and the other thereof is open.
